(19) United States
(12) Patent Application Publication
(10) Pub. No.: US 2024/0264425 A1
(43) Pub. Date: Aug. 8, 2024

(54) Lens Module Including Two Lens Elements Separated by an Air Gap

(71) Applicant: Apple Inc., Cupertino, CA (US)

(72) Inventors: Zachary A. Granger, Redwood City, CA (US); Ran He, Cupertino, CA (US); Graham B. Myhre, Campbell, CA (US); Francois R. Jacob, Sunnyvale, CA (US)

(21) Appl. No.: 18/640,255

(22) Filed: Apr. 19, 2024

Related U.S. Application Data
(63) Continuation of application No. PCT/US22/48093, filed on Oct. 27, 2022.
(60) Provisional application No. 63/274,398, filed on Nov. 1, 2021.

(51) Int. Cl. G02B 25/00; G02C 7/02

(52) U.S. Cl. CPC G02B 25/001; G02C 7/02

(57) ABSTRACT

A head-mounted display may include a display system and an optical system that are supported by a housing. The optical system may be a catadioptric optical system having a removable lens element and a non-removable lens element. The optical system may include a quarter wave plate that is coated to the non-removable lens element without an intervening adhesive layer. The optical system may further include a reflective polarizer and a linear polarizer. The removable lens element may be selectively attached to the optical system. The removable lens element may be separated from a non-removable lens element by an air gap when the removable lens element is attached to the optical system. The removable lens element may have a convex curved surface that conforms to a concave curved surface of the non-removable lens element.

This application is a continuation of international patent application No. PCT/US22/48093, filed Oct. 27, 2022, which claims priority to U.S. provisional patent application No. 63/274,398, filed Nov. 1, 2021, which are hereby incorporated by reference herein in their entireties.

### BACKGROUND

This relates generally to optical systems and, more particularly, to optical systems for head-mounted displays.

Head-mounted displays such as virtual reality glasses use lenses to display images for a user. A microdisplay may create images for each of a user's eyes. A lens may be placed between each of the user's eyes and a portion of the microdisplay so that the user may view virtual reality content.

If care is not taken, a head-mounted display may be cumbersome and tiring to wear. Optical systems for head-mounted displays may use arrangements of lenses that are bulky and heavy. Extended use of a head-mounted display with this type of optical system may be uncomfortable.

It would therefore be desirable to be able to provide improved head-mounted displays.

### SUMMARY

A head-mounted display may include a display system and an optical system. The display system and optical system may be supported by a housing that is worn on a user's head. The head-mounted display may use the display system and optical system to present images to the user while the housing is being worn on the user's head.

The display system may have a pixel array that produces image light associated with the images. The display system may also have a linear polarizer through which image light from the pixel array passes and a quarter wave plate through which the light passes after passing through the linear polarizer.

The optical system may be a catadioptric optical system having at least first and second lens elements. The optical system may include a quarter wave plate that is coated to the first lens element without an intervening adhesive layer. The optical system may further include a reflective polarizer and a linear polarizer.

The second lens element may be a removable lens element that is configured to be selectively attached to the optical system. The second lens element may include one or more attachment structures that are configured to attach to corresponding attachment structures included in the first lens element or a support structure in the device. The second lens element may be separated from the first lens element by an air gap when the second lens element is attached to the optical system.

The second lens element may have a convex curved surface that conforms to the curvature of a concave curved surface in the first lens element. The minimum radius of curvature of the convex curved surface of the second lens element may be within 20% of the minimum radius of curvature of the concave curved surface of the first lens element.

### BRIEF DESCRIPTION OF THE DRAWINGS

FIG. 1 is a diagram of an illustrative head-mounted display in accordance with an embodiment.

FIG. 2 is a diagram of an illustrative head-mounted display showing components of an illustrative optical system in the head-mounted display in accordance with an embodiment.

FIG. 3 is a cross-sectional side view of an illustrative head-mounted display showing how the polarization of light changes when passing through the optical system of FIG. 2 in accordance with an embodiment.

FIG. 4 is a top view of an illustrative lens element with attachment structures on an upper surface in accordance with an embodiment.

FIG. 5 is a cross-sectional side view of an illustrative lens element with attachment structures on an edge surface in accordance with an embodiment.

### DETAILED DESCRIPTION

Head-mounted displays may be used for virtual reality and augmented reality systems. For example, a pair of virtual reality glasses that is worn on the head of a user may be used to provide a user with virtual reality content and/or augmented reality content.

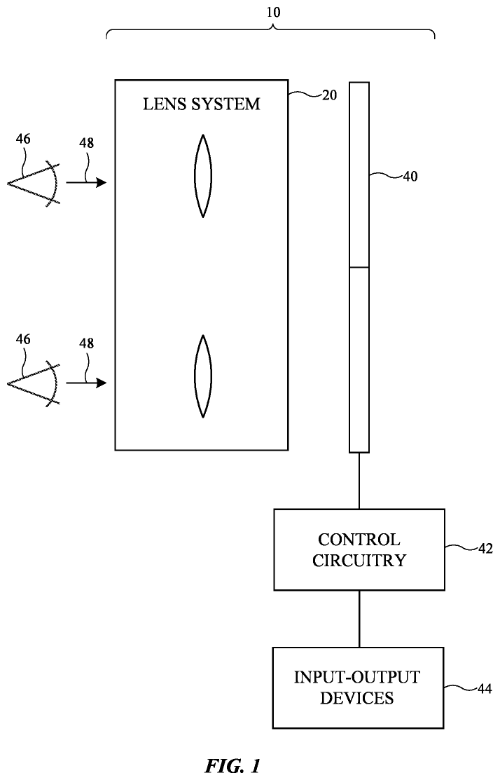

An illustrative system in which an electronic device (e.g., a head-mounted display such as a pair of virtual reality glasses) is used in providing a user with virtual reality content is shown in FIG. 1. As shown in FIG. 1, virtual reality glasses 10 (sometimes referred to as glasses 10, electronic device 10, head-mounted display 10, device 10, etc.) may include a display system such as display system 40 that creates images and may have an optical system such as optical system 20 through which a user (see, e.g., user's eyes 46) may view the images produced by display system 40 by looking in direction 48.

Display system 40 (sometimes referred to as display panel 40 or display 40) may be based on a liquid crystal display, an organic light-emitting diode display, an emissive display having an array of crystalline semiconductor light-emitting diode dies, and/or displays based on other display technologies. Separate left and right displays may be included in system 40 for the user's left and right eyes or a single display may span both eyes.

Visual content (e.g., image data for still and/or moving images) may be provided to display system (display) 40 using control circuitry 42 that is mounted in glasses (head-mounted display) 10 and/or control circuitry that is mounted outside of glasses 10 (e.g., in an associated portable electronic device, laptop computer, or other computing equipment). Control circuitry 42 may include storage such as hard-disk storage, volatile and non-volatile memory, electrically programmable storage for forming a solid-state drive, and other memory. Control circuitry 42 may also include one or more microprocessors, microcontrollers, digital signal processors, graphics processors, baseband processors, application-specific integrated circuits, and other processing circuitry. Communications circuits in circuitry 42 may be used to transmit and receive data (e.g., wirelessly and/or over wired paths). Control circuitry 42 may use display system 40 to display visual content such as virtual reality content (e.g., computer-generated content associated with a virtual world), pre-recorded video for a movie or other media, or other images. Illustrative configurations in which control circuitry 42 provides a user with virtual reality content using display system 40 may sometimes be described herein as an example. In general, however, any suitable content may be presented to a user by control circuitry 42 using display system 40 and optical system 20 of glasses 10.

Input-output devices 44 may be coupled to control circuitry 42. Input-output devices 44 may be used to gather user input from a user, may be used to make measurements on the environment surrounding glasses 10, may be used to provide output to a user, and/or may be used to supply output to external electronic equipment. Input-output devices 44 may include buttons, joysticks, keypads, keyboard keys, touch sensors, track pads, displays, touch screen displays, microphones, speakers, light-emitting diodes for providing a user with visual output, sensors (e.g., a force sensors, temperature sensors, magnetic sensor, accelerometers, gyroscopes, and/or other sensors for measuring orientation, position, and/or movement of glasses 10, proximity sensors, capacitive touch sensors, strain gauges, gas sensors, pressure sensors, ambient light sensors, and/or other sensors). If desired, input-output devices 44 may include one or more cameras/optical sensors (e.g., cameras for capturing images of the user's surroundings, cameras for performing gaze detection operations by viewing eyes 46, and/or other cameras).

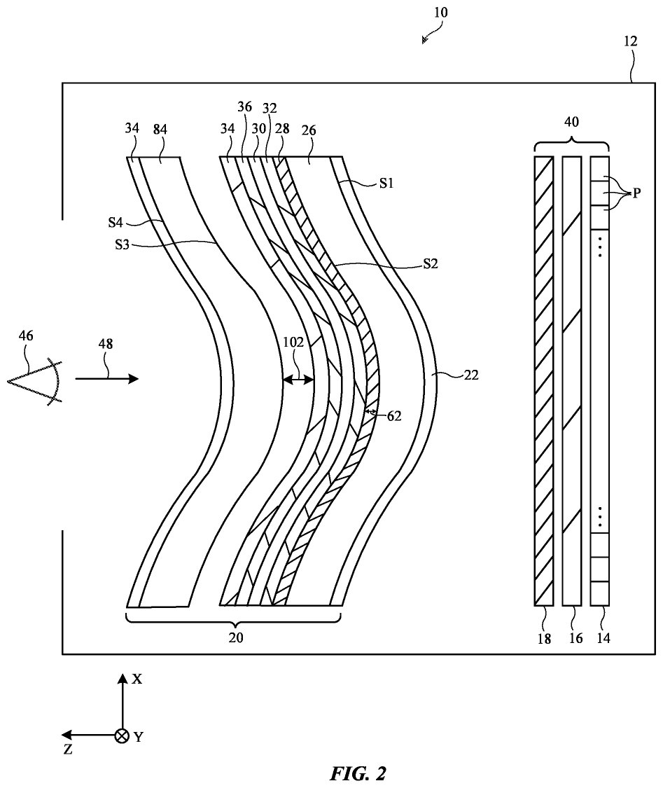

FIG. 2 is a cross-sectional side view of glasses 10 showing how optical system 20 and display system 40 may be supported by head-mounted support structures such as housing 12 for glasses 10. Housing 12 may have the shape of a frame for a pair of glasses (e.g., glasses 10 may resemble eyeglasses), may have the shape of a helmet (e.g., glasses 10 may form a helmet-mounted display), may have the shape of a pair of goggles, or may have any other suitable housing shape that allows housing 12 to be worn on the head of a user. Configurations in which housing 12 supports optical system 20 and display system 40 in front of a user's eyes (e.g., eyes 46) as the user is viewing system 20 and display system 40 in direction 48 may sometimes be described herein as an example. If desired, housing 12 may have other desired configurations.

Housing 12 may be formed from plastic, metal, fiber-composite materials such as carbon-fiber materials, wood and other natural materials, glass, other materials, and/or combinations of two or more of these materials.

Input-output devices 44 and control circuitry 42 may be mounted in housing 12 with optical system 20 and display system 40 and/or portions of input-output devices 44 and control circuitry 42 may be coupled to glasses 10 using a cable, wireless connection, or other signal paths.

Display system 40 and the optical components of glasses 10 may be configured to display images for user 46 using a lightweight and compact arrangement. Optical system 20 may, for example, be based on catadioptric lenses (e.g., lenses that use both reflecting and refracting of light).

Display system 40 may include a source of images such as pixel array 14. Pixel array 14 may include a two-dimensional array of pixels P that emits image light (e.g., organic light-emitting diode pixels, light-emitting diode pixels formed from semiconductor dies, liquid crystal display pixels with a backlight, liquid-crystal-on-silicon pixels with a frontlight, etc.). A polarizer such as linear polarizer 16 may be placed in front of pixel array 14 and/or may be laminated to pixel array 14 to provide polarized image light. Linear polarizer 16 may have a pass axis aligned with the X-axis of FIG. 2 (as an example). Display system 40 may also include a wave plate such as quarter wave plate 18 to provide circularly polarized image light. The fast axis of quarter wave plate 18 may be aligned at 45 degrees relative to the pass axis of linear polarizer 16. Quarter wave plate 18 may be mounted in front of polarizer 16 (between polarizer 16 and optical system 20). If desired, quarter wave plate 18 may be attached to polarizer 16 (and display 14).

Optical system 20 may include a lens element such as lens element 26. Lens element 26 may be formed from a transparent material such as plastic or glass. Lens element 26 may have a surface S1 that faces display system 40 and a surface S2 that faces the user (e.g., eyes 46). Surface S1 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. A freeform surface may include both convex and concave portions. Alternatively, a freeform surface may have varying convex curvatures or varying concave curvatures (e.g., different portions with different radii of curvature, portions with curvature in one direction and different portions with curvature in two directions, etc.). Herein, a freeform surface that is primarily convex (e.g., the majority of the surface is convex and/or the surface is convex at its center) may sometimes still be referred to as a convex surface and a freeform surface that is primarily concave (e.g., the majority of the surface is concave and/or the surface is concave at its center) may sometimes still be referred to as a concave surface. Surface S2 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface.

A spherically curved surface (e.g., a spherically convex or spherically concave surface) may have a constant radius of curvature across the surface. In contrast, an aspherically curved surface (e.g., an aspheric concave surface or an aspheric convex surface) may have a varying radius of curvature across the surface. A cylindrical surface may only be curved about one axis instead of about multiple axes as with the spherical surface. In some cases, one of the lens surfaces may have an aspheric surface that changes from being convex (e.g., at the center) to concave (e.g., at the edges) at different positions on the surface. This type of surface may be referred to as an aspheric surface, a primarily convex (e.g., the majority of the surface is convex and/or the surface is convex at its center) aspheric surface, a freeform surface, and/or a primarily convex (e.g., the majority of the surface is convex and/or the surface is convex at its center) freeform surface. In one illustrative arrangement, shown in FIG. 2, surface S1 is an aspheric convex surface and surface S2 is an aspheric concave surface. This arrangement may be described as an example herein.

Optical structures such as partially reflective coatings, wave plates, reflective polarizers, linear polarizers, antireflection coatings, and/or other optical components may be incorporated into glasses 10 (e.g., system 20, etc.). These optical structures may allow light rays from display system 40 to pass through and/or reflect from surfaces in optical system 20 such as surfaces S1 and S2, thereby providing optical system 20 with a desired lens power.

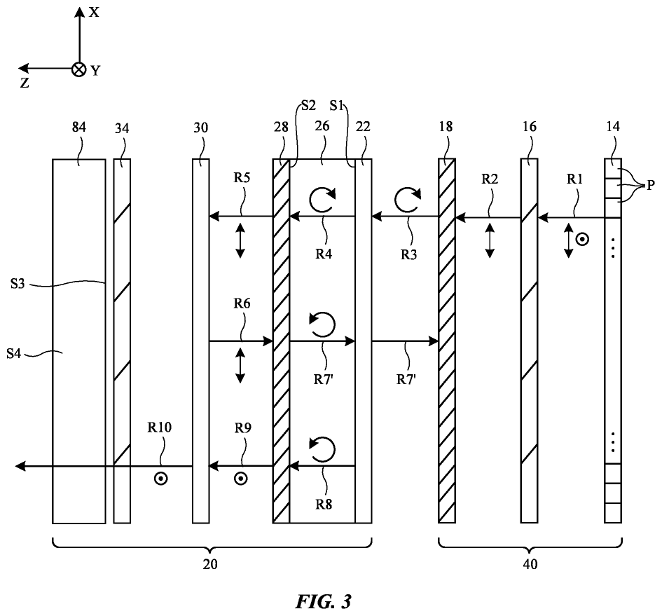

An illustrative arrangement for the optical layers is shown in FIG. 2. First, the structural arrangement of these layers will be described. The functionality of these layers will be discussed in more detail in connection with FIG. 3.

As shown in FIG. 2, a partially reflective mirror (e.g., a metal mirror coating or other mirror coating such as a dielectric multilayer coating with a 50% transmission and a 50% reflection) such as partially reflective mirror 22 may be formed on the aspheric convex surface S1 of lens element 26. Partially reflective mirror 22 may sometimes be referred to as beam splitter 22, half mirror 22, or partially reflective layer 22.

A wave plate such as wave plate 28 may be formed on the aspheric concave surface S2 of lens element 26. Wave plate 28 (sometimes referred to as retarder 28, quarter wave plate 28, etc.) may be a quarter wave plate that conforms to surface S2 of lens element 26. Retarder 28 may be a coating on surface S2 of lens element 26.

Reflective polarizer 30 may be attached to retarder 28 using adhesive layer 32. Reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30. Adhesive layer 32 may be a layer of optically clear adhesive (OCA).

Polarizer 34 may be attached to reflective polarizer 30 using adhesive layer 36. Polarizer 34 may be a linear polarizer. Polarizer 34 may be referred to as an external blocking linear polarizer 34 or cleanup polarizer 34. Linear polarizer 34 may have a pass axis aligned with the pass axis of reflective polarizer 30. Linear polarizer 34 may have a pass axis that is orthogonal to the pass axis of linear polarizer 16. Adhesive layer 36 may be a layer of optically clear adhesive (OCA).

Optical system 20 may include an additional lens element such as lens element 84. Lens element 84 may be formed from a transparent material such as plastic or glass. Lens element 84 may have a surface S3 that faces display system 40 and a surface S4 that faces the user (e.g., eyes 46). Surface S3 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface. Surface S4 may be a convex surface (e.g., a spherically convex surface, a cylindrically convex surface, or an aspherically convex surface), a concave surface (e.g., a spherically concave surface, a cylindrically concave surface, or an aspherically concave surface), or a freeform surface.

In the example of FIG. 2, surface S3 of lens element 84 faces surface S2 of lens element 26. Surface S3 may have convex curvature that matches the shape of the concave curvature of surface S2. Surface S4 may have concave curvature.

In one possible arrangement, lens element 84 may be a removable lens element. In other words, a user may be able to easily remove and replace lens element 84 within optical system 20. This may allow lens element 84 to be customizable. If lens element 84 is permanently affixed to the optical system, the lens power provided by lens element 84 cannot be easily changed. However, by making lens element 84 customizable, a user may select a lens element 84 that best suits their eyes and place the appropriate lens element 84 in the optical system. The lens element 84 may be used to accommodate a user's eyeglass prescription, for example. A user may replace lens element 84 with an updated lens element if their eyeglass prescription changes (without needing to replace any of the other components within device 10). Lens element 84 may have varying lens power and/or may provide varying amount of astigmatism correction to provide prescription correction for the user.

In contrast with lens element 84, lens element 26 may not be a removable lens element. Lens element 26 may therefore be referred to as a permanent lens element, fixed lens element, or non-removable lens element. The example of lens element 26 being a non-removable lens element is merely illustrative. In another possible arrangement, lens element 26 may also be a removable lens element (similar to lens element 84).

An air gap 102 may be present between lens element 84 and lens element 26 (as well as other layers on lens element 26). To improve the performance of the optical system, the curvature of surface S3 of lens element 84 may approximately match the curvature of surface S2 of lens element 26. This results in surface S3 conforming to surface S2 (and the other layers on surface S2 with the same curvature as surface S2 such as layers 28, 32, 30, 36, and 34). Having the curvature of surface S3 match the curvature of surface S2 of lens element 26 in this way allows for the user's eye to be positioned closer to the optical system during operation than if lens 84 had a more planar, non-conforming surface. Positioning the user's eye closer to the optical system improves the user's field of view during operation of the system. Therefore, the curvature of surface S3 allows for the user to experience an improved field of view.

The radius of curvature of surface S3 of lens element 84 may vary across the lens element (e.g., an aspheric lens element as in FIG. 2) or may be constant. The radius of curvature may vary in magnitude and/or sign. The minimum radius of curvature of surface S3 may be less than 15 millimeters, less than 20 millimeters, less than 25 millimeters, less than 30 millimeters, less than 35 millimeters, less than 40 millimeters, less than 50 millimeters, greater than 20 millimeters, between 25 millimeters and 30 millimeters, etc. Similarly, the minimum radius of curvature of surface S2 of lens element 26 may be less than 15 millimeters, less than 20 millimeters, less than 25 millimeters, less than 30 millimeters, less than 35 millimeters, less than 40 millimeters, less than 50 millimeters, greater than 20 millimeters, between 25 millimeters and 30 millimeters, etc. The magnitude of the minimum radius of curvature of surface S3 may be within 1% of the magnitude of the minimum radius of curvature of surface S2, within 5% of the magnitude of the minimum radius of curvature of surface S2, within 10% of the magnitude of the minimum radius of curvature of surface S2, within 20% of the magnitude of the minimum radius of curvature of surface S2, within 50% of the magnitude of the minimum radius of curvature of surface S2, between 1% and 20% of the magnitude of the minimum radius of curvature of surface S2, etc. The radius of curvature may change sign (e.g., change from being convex curvature to concave curvature or vice versa) if desired.

Because surface S3 approximately matches the curvature of surface S2, the width of air gap 102 may be approximately constant across the lens elements. As a specific example, the air gap thickness across the entire surface S3 of lens element 84 may be uniform within 100%, within 50%, within 20%, within 10%, within 5%, within 3%, within 2%, within 1%, etc. The thickness variation of the air gap across surface S3 may be less than 50%, less than 20%, less than 10%, less than 5%, less than 3%, less than 2%, less than 1%, etc.

One or more additional coatings 38 may also be included in optical system 20 (sometimes referred to as lens 20, lens assembly 20, or lens module 20). Coatings 38 may include an anti-reflective coating (ARC), anti-smudge (AS) coating, or any other desired coatings. In the example of FIG. 2, coatings 38 are formed on surface S4 of removable lens element 84.

FIG. 3 is a cross-sectional side view of an illustrative optical system 20 and display system 40 showing how light from the display passes through the optical system of FIG. 2. Note that the adhesive layers 32, 36, and 82 as well as coatings 38 are not shown in FIG. 3 since these layers do not appreciably impact the polarization of light travelling through the system.

As shown in FIG. 3, a light ray R1 may be emitted from display 14. Light ray R1 exits display 14 having a mix of polarization states. As image light ray R1 exits display 14 and passes through linear polarizer 16, ray R1 becomes linearly polarized in alignment with the pass axis of linear polarizer 16. The pass axis of linear polarizer 16 may be, for example, aligned with the X-axis of FIG. 3. After passing through polarizer 16, ray R2 passes through wave plate 18, which may be a quarter wave plate. As ray R2 passes through quarter wave plate 18, ray R3 exits the quarter wave plate circularly polarized (e.g., with a clockwise circular polarization).

When circularly polarized ray R3 strikes partially reflective mirror 22, a portion of ray R3 will pass through partially reflective mirror 22 to become reduced-intensity ray R4. Ray R4 will be refracted (partially focused) by the shape of aspheric convex surface S1 of lens element 26. It should be noted that the depiction of surfaces of S1 and S2 as planar in FIG. 3 is merely illustrative. In practice, surfaces S1 and S2 may be curved (e.g., aspheric convex and aspheric concave) as discussed in connection with FIG. 2.

Wave plate 28 may convert the circular polarization of ray R4 into linear polarization. Quarter wave plate 28 may, for example, convert circularly polarized ray R4 into a ray R5 with a linear polarization aligned with the X-axis of FIG. 2. Quarter wave plate 28 in optical system 20 may be rotated 90 degrees relative to quarter wave plate 18 in display 40 (e.g., the fast axes of quarter wave plates 18 and 28 are orthogonal).

As previously mentioned, reflective polarizer 30 may have orthogonal reflection and pass axes. Light that is polarized parallel to the reflection axis of reflective polarizer 30 will be reflected by reflective polarizer 30. Light that is polarized perpendicular to the reflection axis and therefore parallel to the pass axis of reflective polarizer 30 will pass through reflective polarizer 30. In the illustrative arrangement of FIG. 3, reflective polarizer 30 has a reflection axis that is aligned with the X-axis and a pass axis that is aligned with the Y-axis, so ray R5 will reflect from reflective polarizer 30 as reflected ray R6. It should be noted that the pass axis of reflective polarizer 30 is orthogonal to the pass axis of linear polarizer 16 in display system 40.

Reflected ray R6 has a linear polarization aligned with the X-axis. After passing through quarter wave plate 28, the linear polarization of ray R6 will be converted into circular polarization (i.e., ray R6 will become counter-clockwise circularly polarized ray R7).

Circularly polarized ray R7 will travel through lens element 26 and a portion of ray R7 will be reflected in the positive Z direction by the partially reflective mirror 22 on the convex surface S1 of lens element 26 as reflected ray R8. The reflection from the curved shape of surface S1 provides optical system 20 with additional optical power. It should be noted that any portion of ray R7 that is transmitted by the partially reflective layer 22 (e.g., R7′ in the negative Z-direction) may be converted to a linear polarization by quarter wave plate 18 and then reaches linear polarizer 16. This linearly polarized light has a polarization aligned with the Y-axis (e.g., orthogonal to the pass axis of linear polarizer 16) so that it is absorbed by linear polarizer 16. As a result, contrast degradation and stray light artifacts from this portion of R7 are prevented in the image viewed by the user.

Ray R8 from partially reflective mirror 22 is converted from circularly polarized light to linearly polarized light ray R9 by quarter wave plate 28. Passing through the curved surface S2 of lens element 26 also provides optical system 20 with additional optical power (e.g., refractive optical power). The linear polarization of ray R9 is aligned with the Y-axis, which is parallel to the pass axis of reflective polarizer 30. Accordingly, ray R9 will pass through reflective polarizer 30 as ray R10 to provide a viewable image to the user.

Linear polarizer 34 has a pass axis aligned with the pass axis of reflective polarizer 30 (i.e., parallel to the Y-axis in this example) so that any light from the external environment will be polarized by linear polarizer 34 such that light is not reflected by the reflective polarizer 30. Any light that is transmitted by the linear polarizer 34 and the reflective polarizer 30 will pass through retarders 28 and 18 and be absorbed by linear polarizer 16. Linear polarizer 34 has a pass axis (parallel to the Y-axis) that is orthogonal to the pass axis (parallel to the X-axis) of linear polarizer 16 in the display.

After passing through linear polarizer 34, the light finally passes through lens element 84. Lens element 84 provides optical system 20 with additional optical power (e.g., refractive optical power) at surface S3 and/or surface S4.

Partially reflective layer 22, lens element 26, quarter wave plate 28, reflective polarizer 30, linear polarizer 34, and adhesive layers 32 and 36 may be formed as a solid assembly without any air gaps. As shown in FIG. 2, each one of layers 22, 26, 28, 30, 34, 32, and 36 is attached directly to the adjacent layers. This is particularly noteworthy for the case of retarder 28 being attached directly to the aspheric concave surface S2 of lens element 26.

Conventionally, retarders are planar. However, herein, retarder 28 is a coating that is applied directly on the curved surface of lens element 26 to provide uniform retardation across the lens element. Thereby, retarder 28 in FIG. 2 may have aspheric curvature (e.g., curvature along multiple axes and with different radii of curvature) with a relatively uniform thickness to provide a relatively uniform retardation. Retardation is equal to the thickness of the retarder multiplied by the birefringence of the retarder material. The thickness 62 (shown in FIG. 2) of retarder 28 may be relatively uniform across the optical system (lens assembly). Retarder 28 conforms to the three-dimensional surface of lens element 26 and may sometimes be referred to as a coating (e.g., coating 28 or retarder coating 28).

As specific examples, the retardation provided by retarder 28 across the entire retarder may be uniform within 20%, within 10%, within 5%, within 3%, within 2%, within 1%, etc. Similarly, the thickness 62 of retarder 28 across the entire retarder may be uniform within 20%, within 10%, within 5%, within 3%, within 2%, within 1%, etc. In other words, the retardation variation across the retarder is no more than 20%, no more than 10%, no more than 5%, no more than 3%, no more than 2%, no more than 1%, etc. The thickness variation across the retarder is no more than 20%, no more than 10%, no more than 5%, no more than 3%, no more than 2%, no more than 1%, etc.

Retarder 28 may be formed from any desired materials using any desired processes. As one example, retarder 28 may be formed from a liquid crystal material that is deposited over a photo-aligned alignment layer. As another example, retarder 28 may be formed from a liquid crystal material that is aligned using shear alignment. As yet another example, retarder 28 may be formed from an inorganic material using oblique deposition. The materials for retarder 28 may be deposited using spin coating, spray coating, physical vapor deposition (PVD), or any other desired techniques.

The example of a material having a uniform birefringence and relatively uniform birefringence being used to form the retarder is merely illustrative. Any type of retarder that provides uniform retardation may be used. As one example, the retarder may have a first thickness and a first birefringence in a first portion. The retarder may have a second thickness and a second birefringence in a second portion. The second birefringence may be different than the first birefringence and the second thickness may be different than the first thickness. However, the retardation may be the same in both portions. In other words, the retarder may be provided with different birefringence in different portions that are compensated by different thicknesses in the different portions to provide uniform retardation. These types of techniques may be used to provide uniform retardation even when uniform thickness is not practical from a manufacturing standpoint.

In the example of FIG. 2, reflective polarizer 30 and linear polarizer 34 are formed by optical films that are laminated to the lens assembly using optically clear adhesive. This type of arrangement may be satisfactory for some lens elements 26. Specifically, if the radius of curvature of lens element 26 (and lens element 84) is sufficiently large, reflective polarizer 30 and linear polarizer 34 may be formed using films. However, as the radius of curvature decreases (i.e., the curvature of the lens becomes greater), reflective polarizer 30 and linear polarizer 34 may experience reliability issues (e.g., wrinkling, cracking, etc.) due to the high levels of curvature required. Certain applications may require an optical system to include lens elements with high degrees of curvature. In these applications, it may be desirable to form reflective polarizer 30 and/or linear polarizer 34 as coatings (instead of as films laminated with adhesive).

As a specific example, linear polarizer 34 may be formed as a coating on reflective polarizer 30 (allowing the adhesive layer between linear polarizer 34 and reflective polarizer 30 to be omitted). The coatable linear polarizer may be formed from a layer of liquid crystal polymer or any other desired material that may be used to form a coating. The linear polarizer coating may include dichroic dye in addition to the base material (e.g., liquid crystal polymer). Forming the linear polarizer as a coating allows for more aggressive curvature of the lens elements (and their conformal layers) in optical system 20 without negatively impacting reliability. The thickness of linear polarizer 34 (e.g., when formed as a coating) across the entire polarizer may be uniform within 20%, within 10%, within 5%, within 3%, within 2%, within 1%, etc. The thickness variation across the linear polarizer may be no more than 20%, no more than 10%, no more than 5%, no more than 3%, no more than 2%, no more than 1%, etc.

As another example, a single reflective polarizer and retarder layer may be used instead of a separately formed reflective polarizer 30 and retarder 28 (as in FIG. 2). The reflective polarizer and retarder layer (sometimes referred to as a circular reflective polarizer) may be coated directly on surface S2 of lens element 26. The reflective polarizer and retarder layer may reflect light having a first circular polarization type and may transmit light having a second, opposite circular polarization type. The reflective polarizer and retarder layer may be formed from cholesteric liquid crystal or any other desired materials.

It should be noted that when a reflective polarizer and retarder layer is used, linear polarizer 34 may optionally be omitted entirely. Alternatively, in embodiments with a reflective polarizer and retarder layer 72, a circular polarizer may be used in place of linear polarizer 34.

The example in FIG. 2 of using a single non-removable lens element 26 is merely illustrative. If desired, multiple non-removable lens elements may be used in optical system 20 in addition to removable lens element 84.

In the example of FIG. 2, linear polarizer 34 is formed on surface S2 of lens element 26. In other words, air gap 102 is interposed between lens element 84 and linear polarizer 34. This example is merely illustrative. In another possible arrangement, linear polarizer 34 may be formed on surface S3 of removable lens element 84. The linear polarizer 34 may be coated directly onto surface S3 of removable lens element 84 or may be attached to surface S3 by a layer of adhesive. In this arrangement, air gap 102 is interposed between linear polarizer 34 and reflective polarizer 30 (and lens element 26).

Yet another possibility is to position linear polarizer 34 on surface S4 of removable lens element 84. The linear polarizer 34 may be coated directly onto surface S4 of removable lens element 84 or may be attached to surface S4 by a layer of adhesive. In this arrangement, linear polarizer 34 is interposed between surface S4 and coating(s) 38.

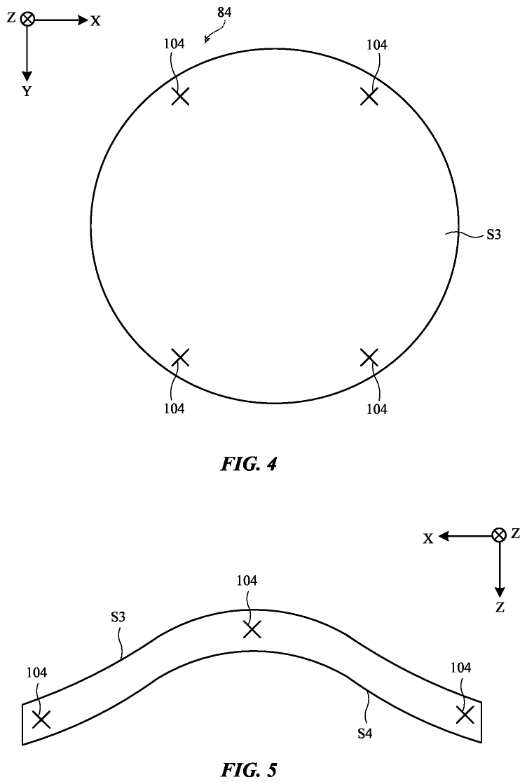

Device 10 may include one or more attachment structures 104 that are used to selectively attach the removable lens element 84 to the device. As shown in FIG. 4, one or more attachment structures 104 may be included on surface S3 of lens element 84. The attachment structures may be, for example, distributed around the periphery of surface S3 (as shown in FIG. 4). The example of having the attachment structures on S3 is merely illustrative. One or more attachment structures 104 may also be included on surface S4 of lens element 84. The attachment structures may be, for example, distributed around the periphery of surface S4. Additionally, one or more attachment structures 104 may be included on an edge surface of lens element 84 that connects surface S3 to S4. FIG. 5 is a cross-sectional side view of lens element 84 showing attachment structures 104 on the edge surface between surfaces S3 and S4. In general, any desired number of attachment structures in any desired locations may be included in device 10 to enable removable lens element 84 to be selectively secured to device 10.

A wide range of attachment structures may be used for attachment structures 104. The attachment structures may include protrusions, recesses, grooves, posts, magnets, hooks, loops, snaps, buttons, suction cups, a draw string, a zipper, adhesive (e.g., tape), a flexible band, or any other desired type of attachment structure. The attachment structures may be attached to corresponding attachment structures on lens element 26 and/or on a support structure within device 10 (e.g., housing 12, a lens module housing formed separately from housing 12, etc.)

Attachment structures 104 on lens element 84 may be protrusions that are configured to mate (interlock) with corresponding recesses. The corresponding recesses may be included on non-removable lens element 26 or on a support structure within device 10 (e.g., housing 12, a lens module housing formed separately from housing 12, etc.). The protrusions on lens element 84 may, as an example, bridge the air gap 102 between lens elements 84 and 26 and protrude into a recess in lens element 26. Layers 34, 36, 30, 32, and/or 28 may have corresponding openings to accommodate the protrusions.

Attachment structures 104 on lens element 84 may be recesses that are configured to mate (interlock) with corresponding protrusions on non-removable lens element 26 or on a support structure within device 10 (e.g., housing 12, a lens module housing formed separately from housing 12, etc.). The protrusions on lens element 26 may, as an example, bridge the air gap 102 between lens elements 84 and 26 and protrude into a recess in lens element 84. Layers 34, 36, 30, 32, and/or 28 may have corresponding openings to accommodate the protrusions.

In the examples where the attachment structures 104 include recesses or protrusions, these features may be molded integrally with lens elements 84 and 26. In other words, the protrusions on lens element 84 may be formed from the same material as lens element 84 (e.g., may be formed in a single molding step with the lens element). The recesses on lens element 84 may be defined by the material of lens element 84 (e.g., may be formed in a single molding step with the lens element). The protrusions on lens element 26 may be formed from the same material as lens element 26 (e.g., may be formed in a single molding step with the lens element). The recesses on lens element 26 may be defined by the material of lens element 26 (e.g., may be formed in a single molding step with the lens element).

Attachment structures 104 may also be magnets (e.g., permanent magnets) that are configured to magnetically couple with corresponding magnets that are included on non-removable lens element 26 or on a support structure within device 10 (e.g., housing 12, a lens module housing formed separately from housing 12, etc.). As yet another example, attachment structures on lens element 84 may be grooves that are configured to mate (interlock) with corresponding posts on lens element 84 or a support structure in the device (e.g., housing 12, a lens module housing formed separately from housing 12, etc.).

The attachment structures 104 may be configured to properly align removable lens element 84 relative to non-removable lens element 26 when lens element 84 is attached to device 10 to ensure satisfactory operation of the optical system. Different types of attachment structures 104 (e.g., protrusions, recesses, and magnets) may be used in a single device.

In accordance with an embodiment, an electronic device configured to display images is provided that includes a display panel configured to produce light for the images, and a lens module that receives the light from the display panel, the lens module includes a first lens element, a second lens element, the second lens element is a removable lens element that is configured to be selectively attached to the lens module, a partially reflective mirror that is interposed between the first lens element and the display panel, a reflective polarizer that is interposed between the first lens element and the second lens element when the second lens element is attached to the lens module, and an air gap that is interposed between the first lens element and the second lens element when the second lens element is attached to the lens module.

In accordance with another embodiment, the first lens element has a first convex surface and a first concave surface and the first convex surface is interposed between the first concave surface and the display panel.

In accordance with another embodiment, the second lens element has a second convex surface and a second concave surface and the second convex surface is interposed between the first concave surface and the second concave surface when the second lens element is attached to the lens module.

In accordance with another embodiment, the first concave surface has a minimum radius of curvature of a first magnitude, the second convex surface has a minimum radius of curvature of a second magnitude, and the second magnitude is within 20% of the first magnitude.

In accordance with another embodiment, the first concave surface has a minimum radius of curvature of a first magnitude, the second convex surface has a minimum radius of curvature of a second magnitude, and the second magnitude is within 5% of the first magnitude.

In accordance with another embodiment, the lens module includes a quarter wave plate that is interposed between the first lens element and the reflective polarizer.

In accordance with another embodiment, the lens module includes a linear polarizer, the reflective polarizer is interposed between the linear polarizer and the quarter wave plate.

In accordance with another embodiment, the lens module includes a layer of adhesive that attaches the linear polarizer to the reflective polarizer.

In accordance with another embodiment, the lens module includes an additional layer of adhesive that attaches the reflective polarizer to the quarter wave plate.

In accordance with another embodiment, the linear polarizer is formed on the second convex surface of the second lens element.

In accordance with another embodiment, the linear polarizer is formed on the second concave surface of the second lens element.

In accordance with another embodiment, the air gap has a thickness that varies by less than 50%.

In accordance with another embodiment, the lens module includes an anti-reflective coating on the second lens element and the second lens element is interposed between the anti-reflective coating and the first lens element when the second lens element is attached to the lens module.

In accordance with another embodiment, the second lens element includes an attachment structure that is configured to attach to a corresponding attachment structure on the first lens element when the second lens element is attached to the lens module.

In accordance with another embodiment, the second lens element includes an attachment structure that is configured to attach to a corresponding attachment structure on a support structure when the second lens element is attached to the lens module.

In accordance with another embodiment, the second lens element is configured to accommodate an eyeglass prescription.

In accordance with an embodiment, an electronic device configured to display images is provided that includes a display panel configured to produce light for the images, and a lens module that receives the light from the display panel, the lens module includes a first lens element having a first convex surface and a first concave surface, a second lens element having a second convex surface and a second concave surface, the second lens element is a removable lens element that is configured to be selectively attached to the lens module, the second convex surface faces the first concave surface when the second lens element is attached to the lens module, the first concave surface has a minimum radius of curvature of a first magnitude, the second convex surface has a minimum radius of curvature of a second magnitude, and the second magnitude is within 20% of the first magnitude, and a partially reflective mirror that is interposed between the first lens element and the display panel.

In accordance with another embodiment, the lens module includes an air gap that is interposed between the first lens element and the second lens element when the second lens element is attached to the lens module.

In accordance with another embodiment, the air gap has a thickness that varies by less than 20%.

In accordance with another embodiment, the lens module includes a reflective polarizer that is interposed between the first lens element and the second lens element when the second lens element is attached to the lens module, a quarter wave plate that is interposed between the first lens element and the reflective polarizer, and a linear polarizer, the reflective polarizer is interposed between the linear polarizer and the quarter wave plate.

In accordance with an embodiment, an electronic device configured to display images is provided that includes a display panel configured to produce light for the images, and a lens module that receives the light from the display panel, the lens module includes a first lens element having first and second opposing surfaces, the first surface faces the display panel, a second lens element having third and fourth opposing surfaces, the second lens element is a removable lens element that is configured to be selectively attached to the lens module, an air gap that is interposed between the first lens element and the second lens element when the second lens element is attached to the lens module, the third surface faces the second surface when the second lens element is attached to the lens module and the third surface has curvature that matches curvature of the second surface, and a partially reflective mirror that is interposed between the first lens element and the display panel.

The foregoing is merely illustrative and various modifications can be made to the described embodiments. The foregoing embodiments may be implemented individually or in any combination.

What is claimed is:

1. An electronic device configured to display images, comprising:
a display panel configured to produce light for the images; and
a lens module that receives the light from the display panel, wherein the lens module comprises:
a first lens element;
a second lens element, wherein the second lens element is a removable lens element that is configured to be selectively attached to the lens module;
a partially reflective mirror that is interposed between the first lens element and the display panel;
a reflective polarizer that is interposed between the first lens element and the second lens element when the second lens element is attached to the lens module; and
an air gap that is interposed between the first lens element and the second lens element when the second lens element is attached to the lens module.

2. The electronic device defined in claim 1, wherein the first lens element has a first convex surface and a first concave surface and wherein the first convex surface is interposed between the first concave surface and the display panel.

3. The electronic device defined in claim 2, wherein the second lens element has a second convex surface and a second concave surface and wherein the second convex surface is interposed between the first concave surface and the second concave surface when the second lens element is attached to the lens module.

4. The electronic device defined in claim 3, wherein the first concave surface has a minimum radius of curvature of a first magnitude, wherein the second convex surface has a minimum radius of curvature of a second magnitude, and wherein the second magnitude is within 20% of the first magnitude.

5. The electronic device defined in claim 3, wherein the first concave surface has a minimum radius of curvature of a first magnitude, wherein the second convex surface has a minimum radius of curvature of a second magnitude, and wherein the second magnitude is within 5% of the first magnitude.

6. The electronic device defined in claim 3, wherein the lens module further comprises:
a quarter wave plate that is interposed between the first lens element and the reflective polarizer.

7. The electronic device defined in claim 6, wherein the lens module further comprises:
a linear polarizer, wherein the reflective polarizer is interposed between the linear polarizer and the quarter wave plate.

8. The electronic device defined in claim 7, wherein the lens module further comprises:
a layer of adhesive that attaches the linear polarizer to the reflective polarizer.

9. The electronic device defined in claim 8, wherein the lens module further comprises:
an additional layer of adhesive that attaches the reflective polarizer to the quarter wave plate.

10. The electronic device defined in claim 7, wherein the linear polarizer is formed on the second convex surface of the second lens element.

11. The electronic device defined in claim 7, wherein the linear polarizer is formed on the second concave surface of the second lens element.

12. The electronic device defined in claim 1, wherein the air gap has a thickness that varies by less than 50%.

13. The electronic device defined in claim 1, wherein the lens module further comprises an anti-reflective coating on the second lens element and wherein the second lens element is interposed between the anti-reflective coating and the first lens element when the second lens element is attached to the lens module.

14. The electronic device defined in claim 1, wherein the second lens element further comprises an attachment structure that is configured to attach to a corresponding attachment structure on the first lens element when the second lens element is attached to the lens module.

15. The electronic device defined in claim 1, wherein the second lens element further comprises an attachment structure that is configured to attach to a corresponding attachment structure on a support structure when the second lens element is attached to the lens module.

16. The electronic device defined in claim 1, wherein the second lens element is configured to accommodate an eyeglass prescription.

17. An electronic device configured to display images, comprising:
a display panel configured to produce light for the images; and
a lens module that receives the light from the display panel, wherein the lens module comprises:
a first lens element having a first convex surface and a first concave surface;
a second lens element having a second convex surface and a second concave surface, wherein the second lens element is a removable lens element that is configured to be selectively attached to the lens module, wherein the second convex surface faces the first concave surface when the second lens element is attached to the lens module, wherein the first concave surface has a minimum radius of curvature of a first magnitude, wherein the second convex surface has a minimum radius of curvature of a second magnitude, and wherein the second magnitude is within 20% of the first magnitude; and
a partially reflective mirror that is interposed between the first lens element and the display panel.

18. The electronic device defined in claim 17, wherein the lens module further comprises:
an air gap that is interposed between the first lens element and the second lens element when the second lens element is attached to the lens module.

19. The electronic device defined in claim 18, wherein the air gap has a thickness that varies by less than 20%.

20. The electronic device defined in claim 19, wherein the lens module further comprises:
a reflective polarizer that is interposed between the first lens element and the second lens element when the second lens element is attached to the lens module;
a quarter wave plate that is interposed between the first lens element and the reflective polarizer; and
a linear polarizer, wherein the reflective polarizer is interposed between the linear polarizer and the quarter wave plate.

21. An electronic device configured to display images, comprising:
a display panel configured to produce light for the images; and
a lens module that receives the light from the display panel, wherein the lens module comprises:
a first lens element having first and second opposing surfaces, wherein the first surface faces the display panel;
a second lens element having third and fourth opposing surfaces, wherein the second lens element is a removable lens element that is configured to be selectively attached to the lens module;
an air gap that is interposed between the first lens element and the second lens element when the second lens element is attached to the lens module, wherein the third surface faces the second surface when the second lens element is attached to the lens module and wherein the third surface has curvature that matches curvature of the second surface; and
a partially reflective mirror that is interposed between the first lens element and the display panel.
